(19) United States
(12) Patent Application Publication
(10) Pub. No.: US 2025/0166401 A1
(43) Pub. Date: May 22, 2025

(54) HARDWARE INTEGRITY VALIDATION

(71) Applicant: INTERNATIONAL BUSINESS MACHINES CORPORATION, ARMONK, NY (US)

(72) Inventors: Abdikarim Hussein, Rochester, MN (US); Theron Lee Lewis, Rochester, MN (US); Timothy Jennings, Rochester, MN (US); James D. Bielick, Pine Island, MN (US); David J. Braun, St. Charles, MN (US); Stephen Michael Hugo, Stewartville, MN (US); John R. Dangler, Rochester, MN (US); Jennifer I. Bennett, Rochester, MN (US)

(21) Appl. No.: 18/513,775

(22) Filed: Nov. 20, 2023

(51) Int. Cl. G06V 20/00; G01N 23/04; G01N 23/083; G06V 10/75

(52) U.S. Cl. CPC G06V 20/95; G01N 23/04; G01N 23/083; G06V 10/751

(57) ABSTRACT

Described is a method for validating hardware integrity on a printed circuit board assembly includes receiving a sample image of a first PCBA, where the first PCBA includes a first PCB with a first plurality of electronic components. The method also includes receiving a baseline image for a second PCBA, where the second PCBA includes a second PCB with a second plurality of electronic components. The method also includes comparing, utilizing differential analysis, the sample image to the baseline image and identifying, based on the comparing, a first area of a first anomaly associated with the first PCBA. The method also includes displaying a composite image highlighting the first area of the first anomaly associated with the first PCBA.

### BACKGROUND

This disclosure relates generally to hardware integrity validation, and in particular to utilizing differential analysis and variance techniques to validate hardware integrity.

Counterfeit components in electronic hardware are a common occurrence in the printed circuit board assembly (PCBA) industry, where components of lower quality and standards are installed on PCBAs present in devices shipped to clients. Counterfeit components can include fraudulently labeled or misrepresented hardware that is manufactured utilizing substandard materials and/or processes. Counterfeit components can be introduced into a supply chain through a variety of channels that include unauthorized distributors, brokered sales, and potentially through direct sales from a counterfeiter. Presently, a number of counterfeit detection techniques exist range from x-ray imaging, chemical analysis, and electrical testing. The counterfeit detection techniques go beyond a visual inspection since a counterfeit component can often appear identical to a genuine component.

### SUMMARY

Embodiments in accordance with the present invention disclose a method, computer program product and computer system for validating hardware integrity, the method, computer program product and computer system can receive a sample image of a first printed circuit board assembly (PCBA), wherein the first PCBA includes a first printed circuit board (PCB) and a first plurality of electronic components mounted on the first PCB. The method, computer program product and computer system can receive a baseline image for a second PCBA, wherein the second PCBA includes a second PCB and a second plurality of electronic components mounted on the second PCB. The method, computer program product and computer system can compare, utilizing differential analysis, the sample image to the baseline image. The method, computer program product and computer system can identify, based on the comparing, a first area of a first anomaly associated with the first PCBA. The method, computer program product and computer system can display a composite image highlighting the first area of the first anomaly associated with the first PCBA.

### BRIEF DESCRIPTION OF THE SEVERAL VIEWS OF THE DRAWINGS

FIG. 1 is a functional block diagram illustrating a computing environment, in accordance with an embodiment of the present invention.

FIG. 2 illustrates an example of challenging detection areas on a printed circuit board assembly, in accordance with an embodiment of the present invention.

FIG. 3 depicts a flowchart of a hardware validation program for validating hardware integrity on a printed circuit board assembly, in accordance with an embodiment of the present invention.

FIG. 4 depicts a flowchart of a hardware validation program for validating hardware integrity on a printed circuit board assembly with artificial intelligent training component, in accordance with an embodiment of the present invention.

FIG. 5A illustrates an example of a 2D x-ray sample image, in accordance with an embodiment of the present invention.

FIG. 5B illustrates an example of a 2D x-ray baseline image, in accordance with an embodiment of the present invention.

FIG. 5C illustrates an example of a differential analysis image for the 2D x-ray sample image from FIG. 5A and the 2D x-ray baseline image from FIG. 5B, in accordance with an embodiment of the present invention.

FIG. 6 illustrates results from a differential analysis highlighting two areas of anomalies between a 2D x-ray sample image and a 2D x-ray baseline image, in accordance with an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments. It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

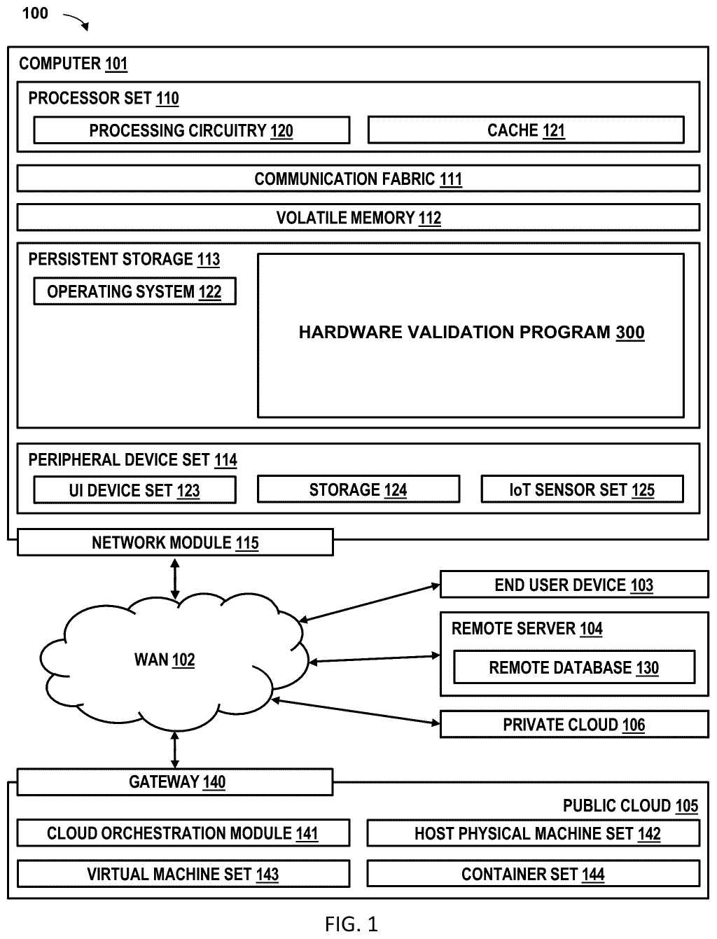

FIG. 1 is a functional block diagram illustrating a computing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Computing environment 100 contains an example of an environment for the execution of at least some of the computer code involved in performing the inventive methods, such as, hardware validation program 300. In addition to block 300, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 300, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 300 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 300 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Embodiments of the present invention provide a hardware validation program for validating hardware integrity on a printed circuit board assembly. Counterfeit electronic components on a PCBA can be used as spy devices, which are often embedded in PCBs. Counterfeit components can be difficult to detect and can lead to data theft and other security breaches. Hardware Trojans are malicious circuits that can be added to PCBs during the manufacturing process and can enable data theft or other security breaches. Rogue devices can be placed in PCBs by third-party manufacturers, which can be used for spying and/or data theft. The global supply chain for electronic components and PCBs is complex and often involves multiple third-party suppliers, which can increase the risk of spy devices being introduced. Embodiments of the present invention utilizes differential analysis to identify and emphasize discrepancies, alteration, and/or deviation within electronic components or PCBs of a PCBA that a conventional x-ray inspection can fail to detect.

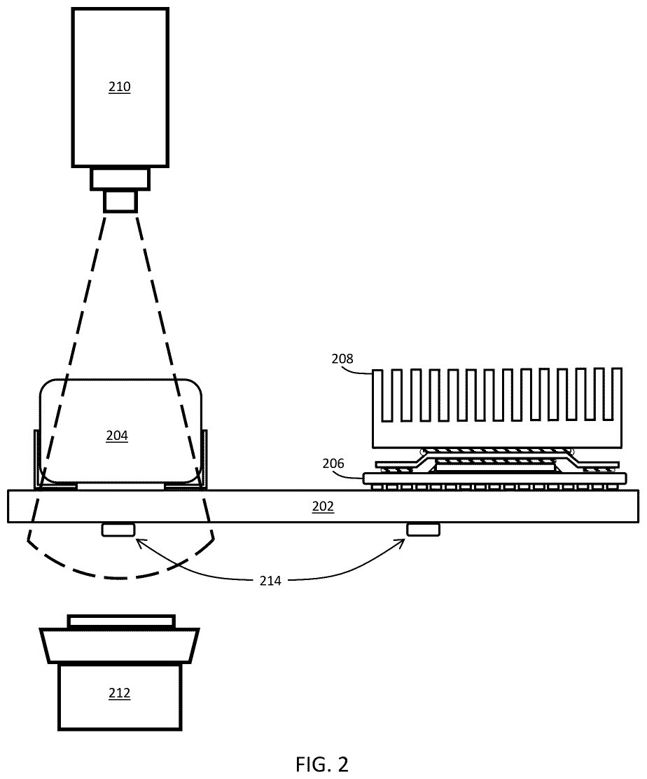

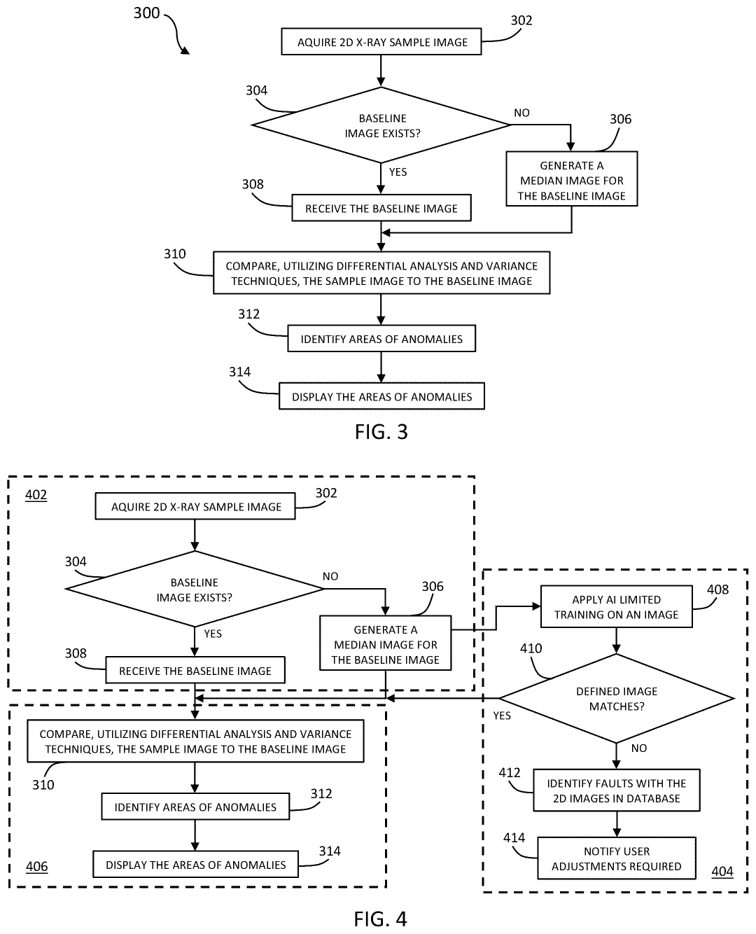

FIG. 2 illustrates an example of challenging detection areas on a printed circuit board assembly, in accordance with an embodiment of the present invention. In this example, printed circuitry board assembly (PCBA) includes printed circuit board (PCB) 202 with various electronic components such as, inductor 204 and application-specific integrated circuit (ASIC) 206 with mounted heatsink 208. X-ray tube 210 is positioned over PCBA and x-ray detector 212 is positioned below PCBA, where x-ray detector 212 aligns with x-ray tube 210. The high variability in product density and construction presents a technical challenge when trying to analyze x-ray images. In this example, inductor 204 and ASIC 206 with mounted heatsink 208 represent dense components which provide challenging detections areas 214 located beneath an area of PCB 202 where inductor 204 and ASIC with heatsink 208 are mounted. The differential analysis and variance techniques of hardware validation program 300 described with respect to FIG. 3, overcome this technical challenge by highlighting differences in the x-ray path from x-ray tube 210 for challenging detection areas 214 due to dense components on the PCBA.

FIG. 3 depicts a flowchart of a hardware validation program for validating hardware integrity on a printed circuit board assembly, in accordance with an embodiment of the present invention.

Hardware validation program 300 acquires a 2D x-ray sample image (302). In this embodiment, hardware validation program 300 acquires a 2D x-ray sample image by receiving an image file for a 2D x-ray scan of a PCBA with various type of mounted electronic components. For consistency, each sample image that hardware validation program 300 acquires is of a set (i.e., identical, or substantially similar) magnification and location, which provides a fixed form factor. Magnification refers to a magnification of a lens for the x-ray and a location refers to a position of the x-ray relative to the PCBA with the various types of mounted electronic components. In other embodiments, the sample image can be a photographic image or a C-Mode (confocal) SAM inspection images. With the set magnification and location for the sample image, hardware validation program 300 can consistently compare the acquired sample image to the baseline image without having to account for additional variations due to magnification and location.

Hardware validation program 300 determines whether a 2D x-ray baseline image exists (decision 304). In the event hardware validation program 300 determines a 2D x-ray baseline image does not exist (“no” branch, decision 304), hardware validation program 300 generates a median image for the baseline image (306). In the event hardware validation program 300 determines a 2D x-ray baseline image does exist (“yes” branch, decision 304), hardware validation program 300 receives the 2D x-ray baseline image (308).

In this embodiment, a baseline image is a benchmark representation for a 2D x-ray of a PCBA with various electronic components to which hardware validation program 300 performs the differential analysis when comparing to the acquired 2D x-ray sample image from (202). The baseline image, often referred to as a control sample, would ideally include few to no manufacturing imperfections, where each electronic component and PCB of the PCBA has been previously verified by a user (e.g., process engineer) to be authentic, with no counterfeit components present. Additionally, the baseline image of the PCBA with the various electronic components would be of the set magnification and location as the 2D x-ray sample image acquired in (202).

Hardware validation program 300 generates a median image for the baseline image (306). In this embodiment, hardware validation program 300 previously determined the baseline image does not exist and hardware validation program 300 generates the median image by receiving numerous 2D x-ray images for multiple samples of the PCBA with the various electronic components. The numerous 2D x-ray images for multiple samples of the PCBA with the various electronic components are for the same PCBA for which hardware validation program 300 acquired the 2D x-ray sample image. Though a small portion of the multiple samples of the PCBA with the various electronic components can include counterfeit components, it is expected that a larger portion and majority would not include the counterfeit components. Therefore, hardware validation program 300 can generate a median image for the baseline image for the PCBA with the various components with the multiple samples, where the median image represents the baseline image for comparing during the differential analysis. Hardware validation program 300 can store the median image as a baseline image in a database to subsequently utilize the baseline image for performing differential analysis on subsequently acquired 2D x-ray sample images.

Hardware validation program 300 receives the 2D x-ray baseline image (308). In this embodiment, hardware validation program 300 queries a database for the 2D x-ray baseline image for the PCBA with the various electronic components based on a model identification number for the sample 2D x-ray sample image. Based on the model identification number for the sample 2D x-ray sample image, hardware validation program 300 can receive the 2D x-ray baseline image from the database for performing the differential analysis between the 2D x-ray sample image and the 2D x-ray baseline image. The 2D x-ray baseline image that hardware validation program 300 stores in the database is the control sample (i.e., benchmark representation) for the PCBA with the various electronic components. As discussed with regards to (306), the 2D x-ray baseline image can be a previously established median image for the specific PCBA with the various electronic components. In another embodiment, the 2D x-ray baseline image was previously provided by user for the PCBA with the various electronic components. The PCBA with the various components provided by the user included few to no manufacturing imperfections, where each electronic component and PCB of the PCBA has been previously verified by the user to be authentic, with no counterfeit components present.

Hardware validation program 300 compares, utilizing differential analysis and variance techniques, the 2D x-ray sample image and the 2D x-ray baseline image (310). For the differential analysis and variance techniques, hardware validation program 300 utilizes a variance script to compares the 2D x-ray sample image and the 2D x-ray baseline image in a single composite image. The variance script is provided below with equation (A):

$$Variance = \frac{\frac{( {sum ( value - mean )}^{2}}{non - transparent pixels}}{( ( number of non - transparent pixels ) - 1 )} \qquad ( A )$$

The variance script that hardware validation program 300 utilizes subtracts each pixel that is present in the 2D x-ray sample image and the 2D x-ray baseline image and highlights each pixel that is not present in the 2D x-ray sample image or the 2D x-ray baseline image. Hardware validation program 300 outputs a single composite image with only differences highlighted and displays the single composite image to a user, where the highlighted differences are visible and easily identifiable by the user viewing the single composite image. Hardware validation program 300 can utilize the variance script when comparing a sample image and a baseline image that are photographical images of the PCBA with the multiple electronic components or a C-Mode (confocal) SAM inspection images of the PCBA with the multiple electronic components. In some embodiments, hardware validation program 300 with the variance script is integrated into an image processing tool, where the image processing tool compares, utilizing the variance script, the 2D x-ray sample image and the 2D x-ray baseline image and generates the single composite image for displaying to the user. The variance script of hardware validation program 300 is a technique that addresses system security by inspecting any PCBA with electronic components for any unauthorized component or circuit additions and/or modifications from an original design.

Hardware validation program 300 identifies areas of anomalies (312). With the variance script, hardware validation program 300 identifies areas of anomalies that represent a variation in a portion of the PCBA with the multiple electronic components of the 2D x-ray sample image and the 2D x-ray baseline image. The portion of the PCBA with the multiple electronic components can include a subarea of a PCB of the PCBA, a subarea of an electronic component from the multiple electronic components, and/or an electronic component from the multiple electronic components. Since hardware validation program 300 generates a single composite image highlighting the differences, the highlighted areas represent areas of anomalies between the 2D x-ray sample image the 2D x-ray baseline image. In some embodiments, hardware validation program 300 can further draw attention to the highlighted areas of the composite image by identifying a specific electronic component with the area of anomaly and outlining the specific electronic component with the area of anomaly, regardless of whether only a portion of the specific electronic component is highlighted in the composite image.

Hardware validation program 300 displays the areas of anomalies (314). Hardware validation program 300 displays the composite image of the PCBA with the multiple electronic components that highlights the differences between the 2D x-ray sample image and the 2D x-ray baseline image. For the composite image, hardware validation program 300 utilizes the 2D x-ray baseline image as a foundation image and highlights one or more areas of anomalies on the foundation image of the 2D x-ray baseline image with respect to the 2D x-ray sample image. In one embodiment, hardware validation program 300 utilizes a distinct color shading to highlight one or more areas of anomalies on the composite image, where a greater intensity of the distinct color shading represents an increased likelihood of an anomaly between the 2D x-ray sample image and the 2D x-ray baseline image. Hardware validation program 300 displays the distinct color shading on the composite image for the areas of the anomalies to the users. In some embodiments, hardware validation program 300 can crop the areas of anomalies for each of the 2D x-ray sample image, the 2D x-ray baseline image, and the composite image, and enhance a magnification for the cropped areas of the anomalies for each of the 3 images. In another embodiment, hardware validation program 300 displays the composite image of the PCBA with the multiple electronic components that highlights the areas of anomalies, along with distinct perimeter outlines of the areas of the anomalies. Hardware validation program 300 can display a distinct perimeter outline of a subarea of the PCB of the PCBA, a subarea of a specific electronic component from the multiple electronic components, and/or an area of the specific electronic component from the multiple electronic components, for the anomalies in the composite image.

FIG. 4 depicts a flowchart of a hardware validation program for validating hardware integrity on a printed circuit board assembly with artificial intelligent training component, in accordance with an embodiment of the present invention. In this embodiment, hardware validation program 300 can train an artificial intelligence (AI) component for instances where a baseline image is does not exist. Machine learning feature 402 of hardware validation program 300 includes analyzing the acquired 2D x-ray sample image from (202) and utilizing training algorithms and models to recognize and classify objects on the acquired 2D x-ray sample image. In the event hardware validation program 300 determines a 2D x-ray baseline image does not exist (“no” branch, decision 304), hardware validation program 300 generates a median image for the baseline image (306) via AI feature 404. In the event hardware validation program 300 determines a 2D x-ray baseline image does exist (“yes” branch, decision 304), hardware validation program 300 receives the 2D x-ray baseline image (308) and subsequently performs a comparison of the 2D x-ray sample image and 2D x-ray baseline image via differential analysis feature 406.

For AI feature 404, hardware validation program 300 applies an AI limited training on an image (408), where the image is the acquired 2D x-ray sample image from (302). Based on the AI limited training of the acquired 2D x-ray sample, hardware validation program 300 determines whether a defined image matches the acquired 2D x-ray sample image (decision 410). In the event hardware validation program 300 determines a defined image does match the acquired 2D x-ray sample image (“yes” branch, decision 410), hardware validation program 300 utilizes the defined image as the 2D x-ray baseline image when comparing, utilizing differential analysis and variance techniques, to the acquired 2D x-ray sample image to identify areas of anomalies (312) and display the areas of anomalies (314).

In the event hardware validation program 300 determines a defined image does not match the acquired 2D x-ray sample image (“no” branch, decision 410), hardware validation program 300 determines there is no standard match with the 2D x-ray images in the database. Hardware validation program 300 identifies faults with the 2D x-ray sample images in the database (412), which can include high image complexity, poor image quality, and/or algorithm limitations of AI feature 404. Hardware validation program 300 notifies the user that adjustments are required to the images to correct the identified faults.

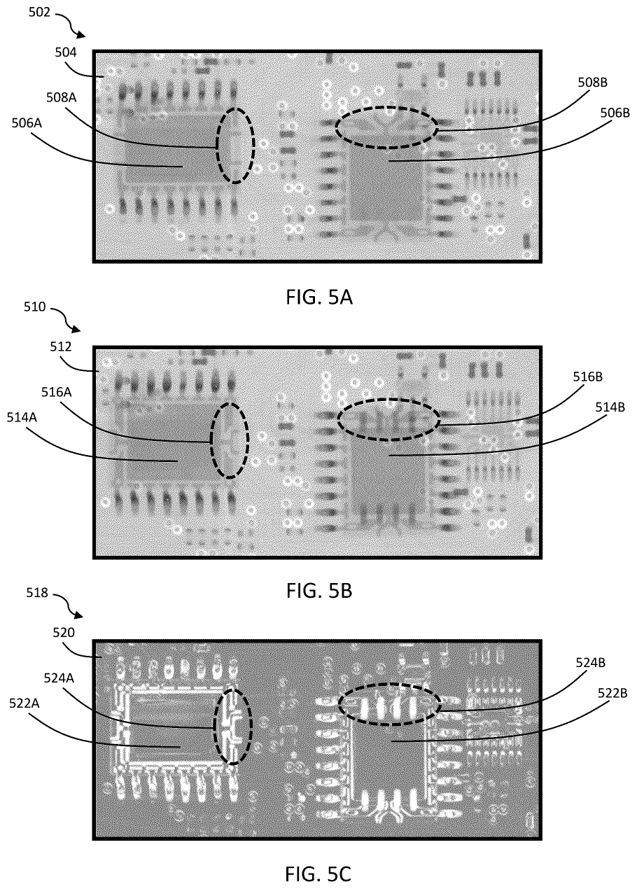

FIG. 5A illustrates an example of a 2D x-ray sample image, in accordance with an embodiment of the present invention. In this example, hardware validation program 300 acquires 2D x-ray sample image 502 of a PCBA that includes PCB 504 with electronic component 506A and 506B. Area 508A includes a subarea of electronic component 506A and area 508B includes a subarea of electronic component 506B.

FIG. 5B illustrates an example of a 2D x-ray baseline image, in accordance with an embodiment of the present invention. In this example, hardware validation program 300 receives 2D x-ray baseline image 510 of a PCBA that includes PCB 512 with electronic component 514A and 514B. Area 516A includes a subarea of electronic component 514A and area 516B includes a subarea of electronic component 514B.

FIG. 5C illustrates an example of a differential analysis image for the 2D x-ray sample image from FIG. 5A and the 2D x-ray baseline image from FIG. 5B, in accordance with an embodiment of the present invention. In this example, hardware validation program 300 generates composite image 518 of a PCBA that includes PCB 520 with electronic component 522A and 522B, where composite image 518 utilizes 2D x-ray baseline image 510 as a foundational image. Area 524A includes a subarea of electronic component 522A and area 524B includes a subarea of electronic component 522B. Area 524A and 524B of composite image 518 represent anomalies where there is a difference between electronic components 506A and 506B of 2D x-ray sample image 502 and electronic components 514A and 514B of 2D x-ray baseline image 510, respectively. In this example, hardware validation program 300 utilizes varying contrast levels to highlight anomalies in composite image 518 where 2D x-ray sample image 502 differs from 2D x-ray baseline image 510. Area 508A and 508B of 2D x-ray sample image 502 differ from respective area 516A and 516B of 2D x-ray baseline image 510, therefore hardware validation program 300 generates composite image 518 highlighting the anomalies on electronic components 522A and 522A with area 524A and 524B.

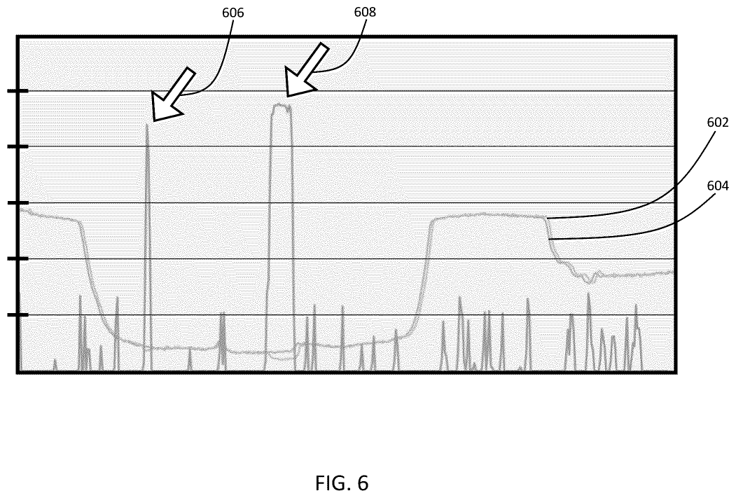

FIG. 6 illustrates results from a differential analysis highlighting two areas of anomalies between a 2D x-ray sample image and a 2D x-ray baseline image, in accordance with an embodiment of the present invention. In this example, the results include sample result line 602 for 2D x-ray sample image 502 and baseline result line 604 for 2D x-ray baseline image 510. A differential line is utilized to display the difference between sample result line 602 and baseline result line 604, where first peak 606 of the differential line corresponds to the anomaly between area 508A and area 516A and second peak 608 of the differential line corresponds to the anomaly between area 508B and area 516B. In some embodiment, hardware validation program 300 can utilize a variation threshold to identify anomalies between the 2D x-ray sample image 502 and 2D x-ray baseline image 510, where meeting or exceeding the variation threshold indicate that an anomaly exists in 2D x-ray sample image 502.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
receiving a sample image of a first printed circuit board assembly (PCBA), wherein the first PCBA includes a first printed circuit board (PCB) and a first plurality of electronic components mounted on the first PCB;
receiving a baseline image for a second PCBA, wherein the second PCBA includes a second PCB and a second plurality of electronic components mounted on the second PCB;
comparing, utilizing differential analysis, the sample image to the baseline image;
identifying, based on the comparing, a first area of a first anomaly associated with the first PCBA; and
displaying a composite image highlighting the first area of the first anomaly associated with the first PCBA.

2. The computer-implemented method of claim 1, wherein comparing, utilizing the differential analysis, the sample image to the baseline image further comprises:
subtracting, utilizing a variance script, each pixel that is present in the sample image and the baseline image; and
highlighting, utilizing the variance script, each pixel that is not present in the sample image or the baseline image.

3. The computer-implemented method of claim 2, further comprising:
generating the composite image highlighting the first area of the first anomaly associated with the first PCBA based on the highlighting of each pixel that is not present in the sample image or the baseline image.

4. The computer-implemented method of claim 3, wherein the composite image utilizes a foundational image for the baseline image.

5. The computer-implemented method of claim 3, wherein the sample image, the baseline image, and the composite image are 2D x-ray images.

6. The computer-implemented method of claim 1, further comprising:
responsive to determining the baseline image does not exist, generating a median image for the baseline image based on a plurality of image samples of a plurality of PCBAs, wherein the plurality of PCBAs include a plurality of PCBs and a plurality of electronic components mounted on each of the plurality of PCBs.

7. The computer-implemented method of claim 1, wherein the first anomaly associated with the first PCBA represents a variation with respect to the second PCBA.

8. A computer program product comprising:
one or more computer-readable storage media;
program instructions, stored on at least one of the one or more storage media, to receive a sample image of a first printed circuit board assembly (PCBA), wherein the first PCBA includes a first printed circuit board (PCB) and a first plurality of electronic components mounted on the first PCB;
program instructions, stored on at least one of the one or more storage media, to receive a baseline image for a second PCBA, wherein the second PCBA includes a second PCB and a second plurality of electronic components mounted on the second PCB;
program instructions, stored on at least one of the one or more storage media, to compare, utilizing differential analysis, the sample image to the baseline image;
program instructions, stored on at least one of the one or more storage media, to identify, based on the comparing, a first area of a first anomaly associated with the first PCBA; and
program instructions, stored on at least one of the one or more storage media, to display a composite image highlighting the first area of the first anomaly associated with the first PCBA.

9. The computer program product of claim 8, wherein program instructions, stored on at least one of the one or more storage media, to compare, utilizing the differential analysis, the sample image to the baseline image further comprises:
program instructions, stored on at least one of the one or more storage media, to subtract, utilizing a variance script, each pixel that is present in the sample image and the baseline image; and
program instructions, stored on at least one of the one or more storage media, to highlight, utilizing the variance script, each pixel that is not present in the sample image or the baseline image.

10. The computer program product of claim 9, further comprising:
program instructions, stored on at least one of the one or more storage media, to generate the composite image highlighting the first area of the first anomaly associated with the first PCBA based on the highlighting of each pixel that is not present in the sample image or the baseline image.

11. The computer program product of claim 10, wherein the composite image utilizes a foundational image for the baseline image.

12. The computer program product of claim 10, wherein the sample image, the baseline image, and the composite image are 2D x-ray images.

13. The computer program product of claim 8, further comprising:
program instructions, stored on at least one of the one or more storage media, responsive to determining the baseline image does not exist, to generate a median image for the baseline image based on a plurality of image samples of a plurality of PCBAs, wherein the plurality of PCBAs include a plurality of PCBs and a plurality of electronic components mounted on each of the plurality of PCBs.

14. The computer program product of claim 8, wherein the first anomaly associated with the first PCBA represents a variation with respect to the second PCBA.

15. A computer system comprising:
one or more processors, one or more computer-readable memories and one or more computer-readable storage media;
program instructions, stored on at least one of the one or more storage media for execution by at least one of the one or more processors via at least one of the one or more memories, to receive a sample image of a first printed circuit board assembly (PCBA), wherein the first PCBA includes a first printed circuit board (PCB) and a first plurality of electronic components mounted on the first PCB;
program instructions, stored on at least one of the one or more storage media for execution by at least one of the one or more processors via at least one of the one or more memories, to receive a baseline image for a second PCBA, wherein the second PCBA includes a second PCB and a second plurality of electronic components mounted on the second PCB;
program instructions, stored on at least one of the one or more storage media for execution by at least one of the one or more processors via at least one of the one or more memories, to compare, utilizing differential analysis, the sample image to the baseline image;
program instructions, stored on at least one of the one or more storage media for execution by at least one of the one or more processors via at least one of the one or more memories, to identify, based on the comparing, a first area of a first anomaly associated with the first PCBA; and
program instructions, stored on at least one of the one or more storage media for execution by at least one of the one or more processors via at least one of the one or more memories, to display a composite image highlighting the first area of the first anomaly associated with the first PCBA.

16. The computer system of claim 15, wherein program instructions, stored on at least one of the one or more storage media for execution by at least one of the one or more processors via at least one of the one or more memories, to compare, utilizing the differential analysis, the sample image to the baseline image further comprises:
program instructions, stored on at least one of the one or more storage media for execution by at least one of the one or more processors via at least one of the one or more memories, to subtract, utilizing a variance script, each pixel that is present in the sample image and the baseline image; and
program instructions, stored on at least one of the one or more storage media for execution by at least one of the one or more processors via at least one of the one or more memories, to highlight, utilizing the variance script, each pixel that is not present in the sample image or the baseline image.

17. The computer system of claim 16, further comprising:
program instructions, stored on at least one of the one or more storage media for execution by at least one of the one or more processors via at least one of the one or more memories, to generate the composite image highlighting the first area of the first anomaly associated with the first PCBA based on the highlighting of each pixel that is not present in the sample image or the baseline image.

18. The computer system of claim 17, wherein the composite image utilizes a foundational image for the baseline image.

19. The computer system of claim 17, wherein the sample image, the baseline image, and the composite image are 2D x-ray images.

20. The computer system of claim 15, further comprising:
program instructions, stored on at least one of the one or more storage media for execution by at least one of the one or more processors via at least one of the one or more memories, responsive to determining the baseline image does not exist, to generate a median image for the baseline image based on a plurality of image samples of a plurality of PCBAs, wherein the plurality of PCBAs include a plurality of PCBs and a plurality of electronic components mounted on each of the plurality of PCBs.
